(19) United States
(12) Patent Application Publication
(10) Pub. No.: US 2013/0287514 A1
(43) Pub. Date: Oct. 31, 2013

(54) METHOD OF MANUFACTURING A GOLF BALL MOLD

(71) Applicant: Huong-Yuan JEAN, Gueisan Hsiang (TW)

(72) Inventor: Huong-Yuan JEAN, Gueisan Hsiang (TW)

(73) Assignee: Q. S. CONTROL CORP.

(21) Appl. No.: 13/456,731

(22) Filed: Apr. 26, 2012

(51) Int. Cl. B23Q 11/00

(52) U.S. Cl. 409/131

(57) ABSTRACT

A method of manufacturing a golf ball mold has steps of preparing a work-in-process golf ball mold, and milling the work-in-process golf ball mold in multiple axial dimensions. In the step of milling the work-in-process golf ball mold in multiple axial dimensions, the work-in-process golf ball mold is processed in a rough-cut way and a finish-machining way. In the finish-machining process, a cutter of a milling machine moves through a helical route.

### BACKGROUND OF THE INVENTION

1. Field of the Invention

The present invention relates to a method of manufacturing a golf ball mold, and more particularly to a method of manufacturing a golf ball mold by milling a work-in-process golf ball mold in multiple axial dimensions.

2. Description of Related Art

A conventional manufacturing method for a golf ball mold uses a way of electroforming. First, a work-in-process mold is provided and has a hemispherical cave formed in the mold. Second, a hemispherical inner shell is mounted on an inner surface of the cave of the work-in-process mold by electroforming and has an inner surface and multiple lumps. The lumps protrude from the inner surface of the inner shell. Accordingly, a hemispherical inner space of the inner shell is capable of shaping a golf ball during injection molding. After the inner shell is securely connected with the work-in-process mold, a golf ball mold is finished.

However, the conventional method of manufacturing a golf ball mold has the following problems.

### 1. Long Manufacturing Time:

Because the electroforming process is highly time-consuming, the conventional manufacturing method for a golf ball mold takes a long time, even as long as numerous days. For examples, manufacturing a navigation button for a cell phone by means of electroforming needs 10-15 days. Moreover, manufacturing a mold for injection molding needs 2-3 weeks.

### 2. Difficulty in Production:

A thickness of a product manufactured by electroforming is difficult to be controlled, especially a thickness of a concave or acute-angled section of the product. Moreover, the electroformed product has large internal stresses and requires further heat-treating.

### 3. Fragility:

Because the inner shell has the lumps, multiple gaps are formed between an outer surface of the inner shell and the inner surface of the cave of the work-in-process mold. Consequently, the inner shell is fragile when pressed during the injection process. And then the shell is scrapped out.

### 4. Tolerances Caused by Assembling:

Because the inner shell and the work-in-process mold are two individual members assembled and welded together, tolerances occur during assembling and welding heat. Besides, the inner surface of the inner shell has its own tolerance, and the total tolerances of the golf ball mold may accumulate beyond estimation. Consequently, multiple golf ball molds have to be prepared for electing one of them to fit with the desired tolerance, so the conventional manufacturing method is time consuming and costly.

To overcome the shortcomings, the present invention tends to provide a method of manufacturing a golf ball mold to mitigate the aforementioned problems.

### SUMMARY OF THE INVENTION

The main objective of the invention is to provide a method of manufacturing a golf ball mold by milling a work-in-process golf ball mold in multiple axial dimensions.

A method of manufacturing a golf ball mold has steps of preparing a work-in-process golf ball mold, and milling the work-in-process golf ball mold in multiple axial dimensions. In the step of milling the work-in-process golf ball mold in multiple axial dimensions, the work-in-process golf ball mold is processed in a rough-cut way and a finish-machining way. In the finish-machining process, a cutter of a milling machine moves through a helical route. The manufacturing method for a golf ball by the milling machine in accordance with the present invention is 3-4 times faster than the conventional manufacturing method by electroforming and can be finished in a day.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a method of manufacturing a golf ball mold in accordance with the present invention;

FIG. 2 is a perspective view of a golf ball mold produced by the method of manufacturing a golf ball mold in accordance with the present invention in FIG. 1;

FIG. 3 is another perspective view of the golf ball mold in FIG. 2;

FIG. 4 is a bottom view of the golf ball mold in FIG. 2; and

FIG. 5 is a cross sectional side view along line 5-5 of the golf ball mold in FIG. 4.

### DETAILED DESCRIPTION OF PREFERRED EMBODIMENT

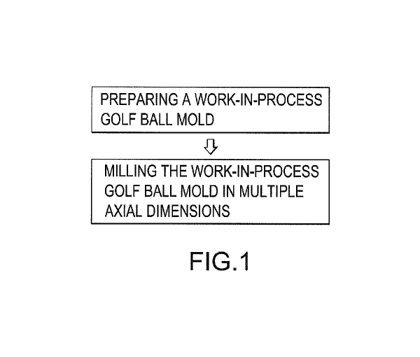

With reference to FIG. 1, a method of manufacturing a golf ball mold in accordance with the present invention comprises the following steps:

### Step A. Preparing a Work-In-Process Golf Ball Mold 10:

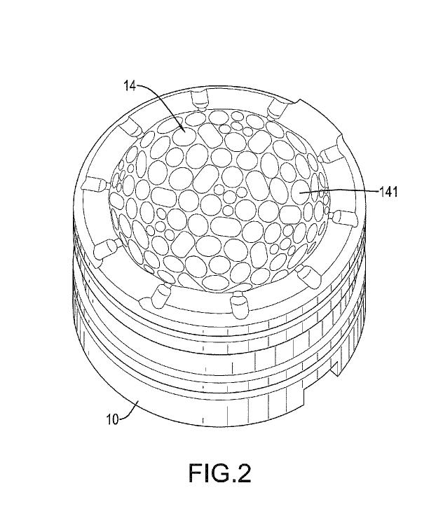

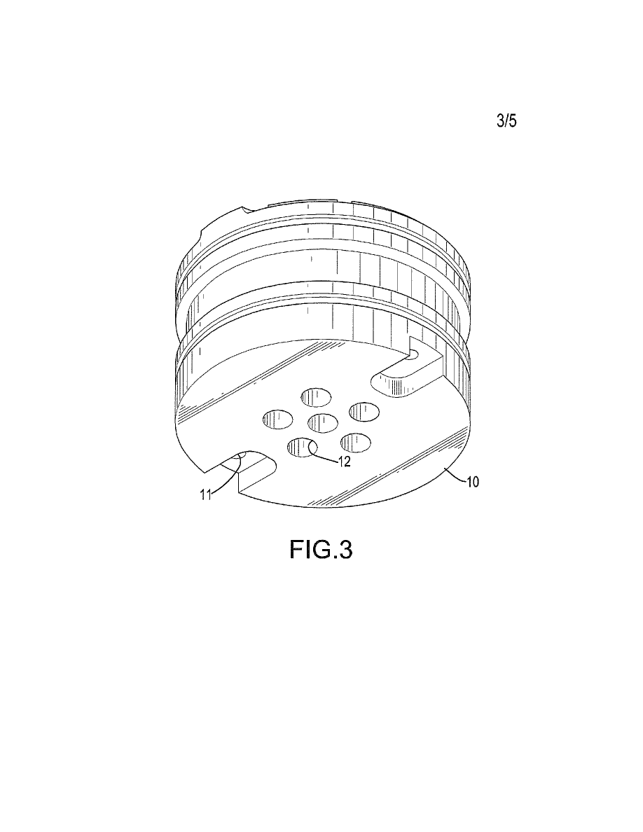

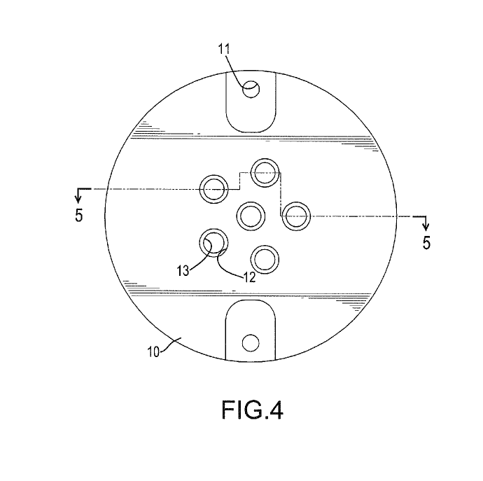

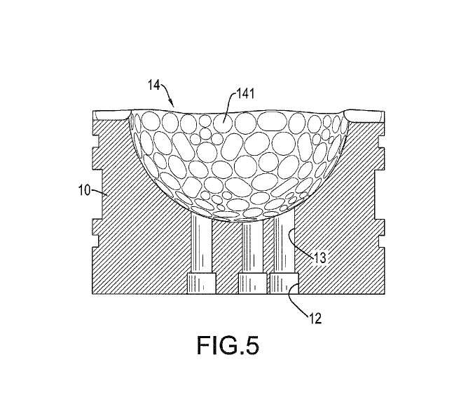

With reference to FIGS. 2 to 5, a metallic beam is cut into a metallic pillar and then the metallic pillar is cut into a work-in-process golf ball mold 10 by a lathe. Accordingly, the cylindrical work-in-process golf ball mold 10 is provided. The work-in-process golf ball mold 10 has a first end surface, a second end surface, two screw holes 11 and multiple pushing rod recesses 12. The second end surface of the work-in-process golf ball mold 10 is opposite to the first end surface of the work-in-process golf ball mold 10 and has a central section. The screw holes 11 are formed in the second end surface of the work-in-process golf ball mold 10, respectively have a round cross section and are respectively located in two opposite ends of a diameter of the second end surface of the work-in-process golf ball mold 10. The pushing rod recesses 12 are longitudinally formed in the central section of the second end surface of the work-in-process golf ball mold 10 beside the screw holes 11.

### Step B. Milling the Work-In-Process Golf Ball Mold in Multiple Axial Dimensions:

Multiple screws are respectively mounted through the screw holes 11 and the work-in-process golf ball mold 10 is mounted securely on a bracket of a milling machine.

The work-in-process golf ball mold 10 is turned by the bracket 180° (degree) for positioning so that the work-in-process golf ball mold 10 is turned upside down. The work-in-process golf ball mold 10 is turned with a precision of 0.005 millimeter.

The first end surface of the work-in-process golf ball mold 10 is processed by the milling machine to shape multiple pushing rod holes 13. The pushing rod holes 13 are respectively formed through the work-in-process golf ball mold 10, respectively communicate with the pushing rod recesses 12, respectively have a round cross section and are respectively concentric to the pushing rod recesses 12. Preferably, a diameter of each pushing rod recess 12 is larger than that of a corresponding one of the pushing rod holes 13. Each pushing rod hole 13 has an adjoining opening.

The first end surface of the work-in-process golf ball mold 10 is processed by the milling machine in a rough-cut way to shape a golf ball shaping cavity 14 in multiple axial dimensions. The golf ball shaping cavity 14 is then finely processed by a cutter of the milling machine in a finish-machining way in multiple axial dimensions. The cutter moves through a helical route when the cutter processes an inner surface of the golf ball shaping cavity 14.

The golf ball shaping cavity 14 is hemispherical and has a shape of a half golf ball. The golf ball shaping cavity 14 has multiple lumps 141 protruding from the inner surface of the golf ball shaping cavity 14. Number of the lumps 141 is larger than that of the pushing rod holes 13.

The adjoining openings of the pushing rod holes 13 are formed on the inner surface of the golf ball shaping cavity 14 beside the lumps 141.

From the above description, it is noted that the present invention has the following advantages:

### 1. Fast Manufacturing Speed:

The manufacturing method for a golf ball by the milling machine in accordance with the present invention is 3-4 times faster than the conventional manufacturing method by electroforming and can be finished in a day.

### 2. Uniform Accuracy:

Because the work-in-process golf ball mold 10 is processed by a milling machine providing an accurate manufacturing process, each work-in-process golf ball mold 10 produced by the manufacturing method for a golf ball mold in accordance with the present invention has uniform accuracy and a uniform shape.

### 3. Good Quality of the Golf Ball Shaping Cavity 14:

Because the pushing rod holes 13 are processed from the first end surface of the work-in-process golf ball mold 10, burrs of the adjoining opening of the pushing rod holes 13 face the pushing rod recesses 12, instead of the golf ball shaping cavity 14. Because burrs of the pushing rod holes 13 do not protrude out from the inner surface of the golf ball shaping cavity 14, the inner surface of the golf ball shaping cavity 14 is not damaged and quality of the golf ball shaping cavity 14 is excellent.

### 4. Excellent Product:

Because the golf ball shaping cavity 14 is then finely processed by a cutter of the milling machine moving through a helical route, manufacturing precision of the golf ball shaping cavity 14 of each golf ball mold ranges from 0.02 millimeter to 0.05 millimeter. Quality of each golf ball produced from the work-in-process golf ball mold 10 manufactured by the manufacturing method of a golf ball mold in accordance with the present invention is as excellent as that of the conventional golf ball produced from the conventional golf ball mold manufactured by electroforming.

### 5. Good Precision:

The work-in-process golf ball mold 10 is turned by the bracket 180° (degree) with a precision of 0.005 millimeter. This means that processing the pushing rod holes 13 has small tolerances so that the pushing rod holes 13 are concentric to the pushing rod recesses 12. A tolerance of a distance between centers of the pushing rod hole 13 and the pushing rod recess 12 can be controlled to an extent of 0.005 millimeter.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of manufacturing a golf ball mold comprising steps of:
preparing a work-in-process golf ball mold, wherein a cylindrical work-in-process golf ball mold is provided; and the work-in-process golf ball mold has
a first end surface;
a second end surface opposite to the first end surface of the work-in-process golf ball mold;
multiple screw holes formed in the second end surface of the work-in-process golf ball mold and respectively having a round cross section; and
multiple pushing rod recesses formed in the second end surface of the work-in-process golf ball mold beside the screw holes; and
milling the work-in-process golf ball mold in multiple axial dimensions, wherein multiple screws are respectively mounted through the screw holes and the work-in-process golf ball mold is securely mounted on a bracket of a milling machine;
the work-in-process golf ball mold is turned by the bracket 180° (degree) for positioning so that the work-in-process golf ball mold is turned upside down;
the first end surface of the work-in-process golf ball mold is processed by the milling machine to shape multiple pushing rod holes;
the pushing rod holes are respectively formed through the work-in-process golf ball mold, respectively communicate with the pushing rod recesses, respectively have a round cross section and are respectively concentric to the pushing rod recesses;
the first end surface of the work-in-process golf ball mold is processed by the milling machine in a rough-cut way to shape a golf ball shaping cavity in multiple axial dimensions; and
the golf ball shaping cavity is then finely processed by a cutter of the milling machine in a finish-machining way in multiple axial dimensions; and
the cutter moves through a helical route when the cutter processes an inner surface of the golf ball shaping cavity.

2. The method of manufacturing a golf ball mold as claimed in claim 1, wherein a diameter of each pushing rod recess is larger than that of a corresponding one of the pushing rod holes;
the golf ball shaping cavity has multiple lumps protruding from the inner surface of the golf ball shaping cavity; and
each pushing rod hole has an adjoining opening formed on the inner surface of the golf ball shaping cavity beside the lumps.

3. The method of manufacturing a golf ball mold as claimed in claim 1, wherein in the step of preparing the work-in-process golf ball mold, a metallic beam is cut into a metallic pillar and then the metallic pillar is cut into the work-in-process golf ball mold by a lathe; and in the step of milling the work-in-process golf ball mold in multiple axial dimensions, the work-in-process golf ball mold is turned by the bracket 180° (degree) with a precision of 0.005 millimeter.

4. The method of manufacturing a golf ball mold as claimed in claim 2, wherein in the step of preparing the work-in-process golf ball mold, a metallic beam is cut into a metallic pillar and then the metallic pillar is cut into the work-in-process golf ball mold by a lathe; and in the step of milling the work-in-process golf ball mold in multiple axial dimensions, the work-in-process golf ball mold is turned by the bracket 180° (degree) with a precision of 0.005 millimeter.
